(19) United States
(12) Patent Application Publication
(10) Pub. No.: US 2024/0288554 A1
(43) Pub. Date: Aug. 29, 2024

(54) LASER RADAR DEVICE

(71) Applicant: Mitsubishi Electric Corporation, Tokyo (JP)

(72) Inventors: Junia NOMURA, Tokyo (JP); Takayuki YANAGISAWA, Tokyo (JP); Yusuke ITO, Tokyo (JP); Wataru YOSHIKI, Tokyo (JP)

(73) Assignee: Mitsubishi Electric Corporation, Tokyo (JP)

(21) Appl. No.: 18/647,456

(22) Filed: Apr. 26, 2024

Related U.S. Application Data
(63) Continuation of application No. PCT/JP2021/048461, filed on Dec. 27, 2021.

(51) Int. Cl. G01S 7/484; G01S 17/10

(52) U.S. Cl. CPC G01S 7/484; G01S 17/10

(57) ABSTRACT

A laser radar device according to the present disclosed technology includes: a seed-light source to generate pulsed light; an intensity modulated signal generator to generate an intensity modulated signal; and an intensity modulated pulse generator to generate intensity modulated pulsed light on the basis of the pulsed light and the intensity modulated signal. The intensity modulated signal generator includes a branching ratio adjuster and a delayed optical path adjuster, the intensity modulated pulse generator includes an optical path coupler, a variable branching-ratio optical-path branch, and a delayed optical path, which are coupled in a loop shape, the branching ratio adjuster outputs a branching-ratio adjustment signal to determine a branching ratio in the variable branching-ratio optical-path branch, and the variable branching-ratio optical-path branch outputs one branched light to a transmission-side optical system and outputs remaining branched light to the delayed optical path on the basis of the branching-ratio adjustment signal.

This application is a Continuation of PCT International Application No. PCT/JP2021/048461, filed on Dec. 27, 2021, all of which are hereby expressly incorporated by reference into the present application.

### TECHNICAL FIELD

The present disclosed technology relates to a laser radar device.

### BACKGROUND ART

In the technical field of laser radars, a technique of measuring a distance using the principle of time of flight (TOF) is known. In addition, a method using an intensity modulated pulse as transmission light used for the TOF (hereinafter, referred to as “intensity modulated pulse-based TOF method”) is also known.

For example, Non-Patent Literature 1 discloses a technique related to the intensity modulated pulse-based TOF method.

### CITATION LIST

### Non-Patent Literatures

Non-Patent Literature 1: L. J. Mullen et al, “Application of RADAR technology to aerial LIDAR systems for enhancement of shallow underwater target detection”, IEEE Transactions on Microwave Theory and Techniques, vol. 43, no. 9, pp. 2370-2377 September 1995.

### SUMMARY OF INVENTION

### Technical Problem

In a laser radar device adopting an intensity modulated pulse-based TOF method, there is a demand for freely changing a maximum measurement distance or distance resolution depending on the purpose of distance measurement by an external operation. The present disclosed technology solves this problem, and an object of the present disclosure is to provide a laser radar device capable of changing a maximum measurement distance or distance resolution depending on the purpose of distance measurement by an external operation.

### Solution to Problem

A laser radar device according to the present disclosed technology includes: a seed-light source to generate pulsed light; an intensity modulated signal generator to generate an intensity modulated signal; and an intensity modulated pulse generator to generate intensity modulated pulsed light on a basis of the pulsed light and the intensity modulated signal. The intensity modulated signal generator includes a branching ratio adjuster and a delayed optical path adjuster, the intensity modulated pulse generator includes an optical path coupler, a variable branching-ratio optical-path branch, and a delayed optical path, which are coupled in a loop shape, the branching ratio adjuster outputs a branching-ratio adjustment signal to determine a branching ratio in the variable branching-ratio optical-path branch, and the variable branching-ratio optical-path branch outputs one branched light to a transmission-side optical system and outputs remaining branched light to the delayed optical path on a basis of the branching-ratio adjustment signal.

### Advantageous Effects of Invention

Since the laser radar device according to the present disclosed technology includes the variable branching-ratio optical-path branch and the branching ratio adjuster, the modulation frequency of amplitude modulation, a pulse train width, and the shape of an amplitude modulation envelope can be changed by an external operation. By changing the modulation frequency of the amplitude modulation, the pulse train width, and the shape of the amplitude modulation envelope by an external operation, the laser radar device according to the present disclosed technology can change the maximum measurement distance or distance resolution by an external operation depending on the purpose of distance measurement.

### BRIEF DESCRIPTION OF DRAWINGS

FIG. 1A is a schematic diagram illustrating that a laser radar device irradiates a target with laser light. FIG. 1B is a graph showing transmission light intensity and received light intensity after filter processing. FIG. 1C is a graph showing a relationship between the transmission light intensity and an intensity modulated pulse. FIG. 1 is a schematic diagram illustrating an intensity modulation method as a whole.

FIG. 2A is a table summarizing effects when a pulse train width δtₘ and an intensity modulation frequency f_{AM} are changed. FIG. 2B is a table showing how the degree of matching between a signal processing filter function and an envelope shape affects the maximum measurement distance. FIG. 2C is a table showing a relationship between the symmetry of the envelope shape and the maximum measurement distance. FIG. 2D is a table showing a correlation between each controlled variable and each parameter.

FIG. 3 is a schematic diagram illustrating a hardware configuration of a signal processing unit 8 in a laser radar device according to a first embodiment.

FIG. 4 is a block diagram illustrating functional blocks of the laser radar device according to the first embodiment.

FIG. 5 is a block diagram illustrating functional blocks of an intensity modulated pulse generator unit 2 and an intensity modulated signal generator unit 11 in the laser radar device according to the first embodiment.

FIG. 6 is a block diagram illustrating functional blocks of the signal processing unit 8 in the laser radar device according to the first embodiment.

FIG. 7 is a flowchart illustrating processing steps performed by the laser radar device according to the first embodiment.

FIG. 8A is an example of a time axis graph of a received electrical signal output from a light receiver unit 7. FIG. 8B is an example of a time axis graph of a received electrical signal output from an integration processing unit 805. FIG. 8 is a graph showing how a received electrical signal is processed by the signal processing unit 8 according to the first embodiment.

FIG. 9 is an example of a graph showing a result of processing the received electrical signal by the signal processing unit 8 of the laser radar device according to the first embodiment.

FIG. 10 is a block diagram illustrating functional blocks of the signal processing unit 8 in a laser radar device according to a second embodiment.

FIG. 11 is a flowchart illustrating a part of processing steps performed by the laser radar device according to the second embodiment.

### DESCRIPTION OF EMBODIMENTS

In general, the time-varying waveform of an optical electric field E with an optical frequency f_{c} may be expressed by the following mathematical formula.

$$E ( t ) = {E}_{0} sin ( 2 π {f}_{c} t ) \qquad ( 1 )$$

wherein E₀ represents the amplitude of an optical electric field E(t).

An intensity modulation frequency f_{AM} used by the present disclosed technology is different from the optical frequency f_{c} in formula (1).

$$\begin{matrix}I ( t ) = {I}_{0} sin ( 2 π {f}_{AM} t ) \\ wherein \\ {I}_{0} = 〈 {\vert E ( t ) \vert}^{2} 〉\end{matrix} \qquad ( 2 )$$

A subscript “AM” of the intensity modulation frequency f_{AM} is an acronym of Amplitude Modulation, which means amplitude modulation. In the formula, I₀ is the amplitude of light intensity I(t) and is represented by the root mean square of the optical electric field E(t). The symbol <> in formula (2) represents an operation of calculating an average value when the time is sufficiently long.

In a case where a frequency characteristic is displayed, an angular frequency ω may be used instead of the frequency f. The relationship between the frequency f and the angular frequency ω is as follows.

$$2 π f = ω \qquad ( 3 )$$

Note that the angular frequency ω is also referred to as “angular frequency” or “angular velocity”.

A pulse obtained by applying intensity modulation to a light pulse with intensity I(t) at a certain intensity modulation frequency f_{AM} is generally referred to as “intensity modulated pulse”. In addition, a multi-pulse train in which several small pulses are arranged in parallel may also be used as a pseudo intensity modulated pulse. Since this multi-pulse train can also be said to be the intensity modulated pulse in a broad sense, it is also referred to herein as “intensity modulated pulse (in the first embodiment, “intensity modulated pulse T”).

### First Embodiment

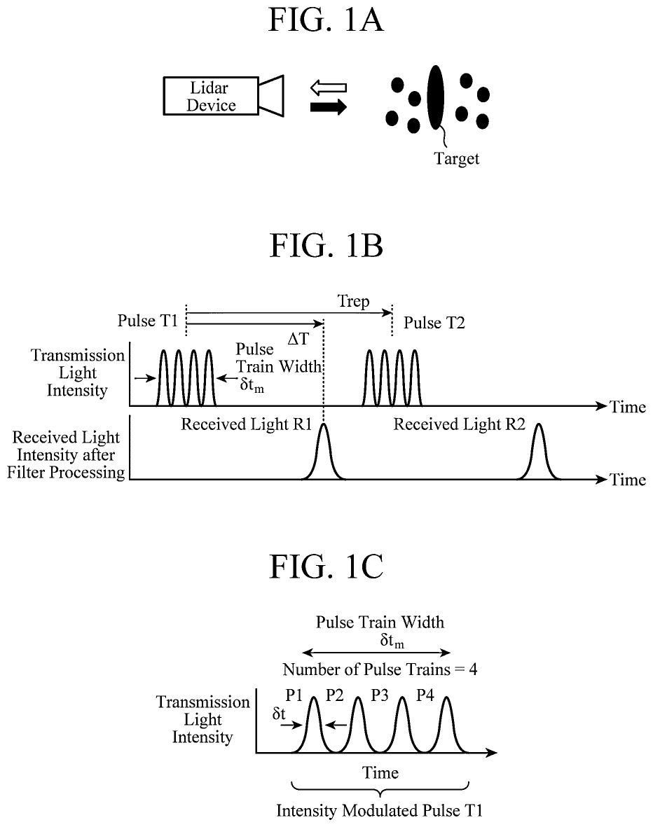

FIG. 1A is a schematic diagram illustrating that a laser radar device irradiates a target with laser light. Details of the target illustrated in FIG. 1A will be apparent from the following description.

FIG. 1B is a graph showing transmission light intensity and received light intensity after filter processing. The graph in the upper part of FIG. 1B is a graph in which the vertical axis represents the transmission light intensity and the horizontal axis represents time. As shown in the graph in the upper part of FIG. 1B, the time interval between a first intensity modulated pulse T1 and a second intensity modulated pulse T2 is a repetition period Trep. The graph in the lower part of FIG. 1B is a graph in which the vertical axis represents the received light intensity after filter processing and the horizontal axis represents the time. As shown in the upper graph and the lower graph of FIG. 1B, the time interval between the first intensity modulated pulse T1 and first received light R1 is ΔT. ΔT, which is a time interval between the first intensity modulated pulse T1 and the first received light R1, is a time from when light is emitted to when the light is reflected by the target and received. Note that, in FIG. 1B, the first intensity modulated pulse T1 is simply referred to as “pulse T1”, and the second intensity modulated pulse T2 is simply referred to as “pulse T2” due to space limitation.

FIG. 1C is a graph showing a relationship between the transmission light intensity and an intensity modulated pulse T. The graph shown in FIG. 1C is a graph in which the vertical axis represents the transmission light intensity and the horizontal axis represents the time. The example shown in FIG. 1C illustrates that the first intensity modulated pulse Tl with a pulse train width δtₘ includes four pulses with a seed-light pulse width δt (P1, P2, P3, and P4).

FIG. 1 is a schematic diagram illustrating an intensity modulation method as a whole. Laser radars are also referred to as “LiDAR (Light Detection and Ranging or Laser Imaging Detection and Ranging)” or “LADAR” (often mainly in military areas).

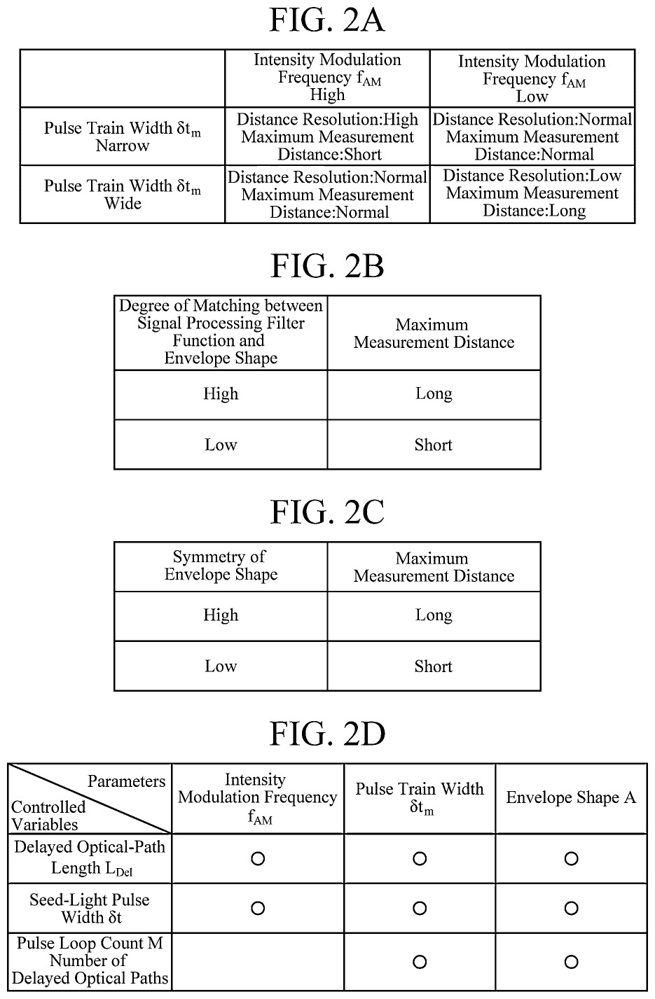

FIG. 2A is a table summarizing effects when the pulse train width δtₘ and the intensity modulation frequency f_{AM} are changed. As shown in FIG. 2A, the laser radar device has characteristics that the narrower the pulse train width δtₘ, the higher the distance resolution, and the wider the pulse train width δtₘ, the longer the maximum measurement distance. In addition, as shown in FIG. 2A, the laser radar device has characteristics that the higher the intensity modulation frequency f_{AM}, the higher the distance resolution, and the lower the intensity modulation frequency f_{AM}, the longer the maximum measurement distance.

FIG. 2B is a table showing how the degree of matching between a signal processing filter function and a shape A of an amplitude modulation envelope affects the maximum measurement distance. The shape A of the amplitude modulation envelope in the table of FIG. 2 represents the relationship between the time axis and the power in the entire pulse train. As shown in FIG. 2B, the laser radar device has characteristics that the maximum measurement distance becomes longer as the pass frequency band of a signal processing filter matches the frequency component of the envelope shape A.

FIG. 2C is a table showing a relationship between the symmetry of the shape A of the amplitude modulation envelope and the maximum measurement distance. As shown in FIG. 2C, the laser radar device has characteristics that the maximum measurement distance becomes longer as the symmetry of the shape A of the amplitude modulation envelope is higher.

It can also be said that FIGS. 2B and 2C show guidelines on what envelope shape A should be adopted by a user in the laser radar device according to the present disclosed technology in which the shape A of the amplitude modulation envelope can be deformed by an external operation.

FIG. 2D is a table showing a correlation between each controlled variable and each parameter. More specifically, FIG. 2D shows that the intensity modulation frequency f_{AM} can be changed by controlling a delayed optical path length L_{Del} or the seed-light pulse width δt. As shown in FIG. 2D, the laser radar device has characteristics that the pulse train width δtₘ or the envelope shape A can be changed by controlling the delayed optical path length L_{Del}, the seed-light pulse width δt, or a pulse loop count. Note that, as shown in FIG. 2D, the pulse loop count may be the number of delayed optical paths. The laser radar device according to the present disclosed technology may change the values of the delayed optical path length L_{Del}, the seed-light pulse width δt, and the pulse loop count or the number of delayed optical paths by an external operation. It is needless to mention that the user may change some of the values of the delayed optical path length L_{Del}, the seed-light pulse width δt, and the pulse loop count or the number of delayed optical paths by an external operation, or may change all the values.

As a whole, it can also be said that FIG. 2 is a summary of parameters that can be set by the user and effects of operating the parameters in the laser radar device according to the present disclosed technology. Specifically, the parameters include the intensity modulation frequency f_{AM}, the pulse train width δtₘ, and the envelope shape A, as shown in FIG. 2D. The user may set only one of the intensity modulation frequency f_{AM}, the pulse train width δtₘ, and the envelope shape A, or may set some of them.

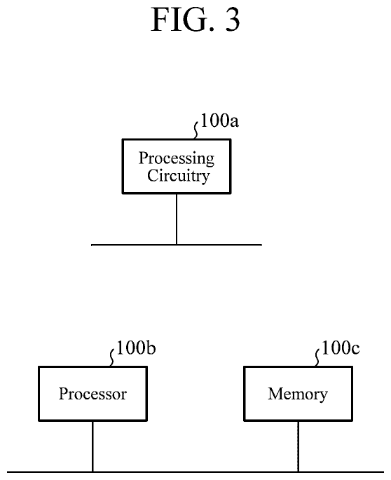

FIG. 3 is a schematic diagram illustrating a hardware configuration of a signal processing unit 8 (to be described later) in the laser radar device according to the first embodiment. Each function of the signal processing unit 8 in the laser radar device is implemented by a processing circuitry. The processing circuitry may be dedicated hardware or a CPU (central processing unit) (also called “central processing device”, “processing device”, “arithmetic device”, “microprocessor”, “microcomputer”, “processor”, or “digital signal processor (DSP)”), that executes a program stored in a memory.

The upper part of FIG. 3 illustrates a case where each function of the signal processing unit 8 is dedicated hardware. A processing circuitry 100a corresponds to, for example, a single circuit, a composite circuit, a programmed processor, a parallel programmed processor, ASIC, FPGA, or a combination thereof. The functions of the individual units of the signal processing unit 8 may be implemented by the individual processing circuities 100a, or the functions of the individual units may be collectively implemented by one processing circuitry 100a.

The lower part of FIG. 3 illustrates a case where each function of the signal processing unit 8 is executed by software. In a case where the processing circuitry is a CPU, for example, a processor 100b, each function of the signal processing unit 8 is implemented by software, firmware, or a combination of software and firmware. The software and firmware are described as programs and stored in a memory 100c. By reading and executing the program stored in the memory 100c, the processing circuitry implements the function of each unit. That is, the signal processing unit 8 of the laser radar device includes the memory 100c for storing a program that results in processing steps of the signal processing unit 8 being performed when executed by the processing circuitry. It can also be said that these programs cause a computer to perform procedures or methods of the individual units of the signal processing unit 8. Here, the memory 100c may be a nonvolatile or volatile semiconductor memory such as RAM, ROM, a flash memory, EPROM, or EEPROM. The memory 100c may also be a magnetic disk, a flexible disk, an optical disk, a compact disk, a mini disk, a DVD, or the like. Furthermore, the memory 100c may be an HDD or an SSD.

Note that some of the functions of the signal processing unit 8 in the laser radar device may be implemented by dedicated hardware, and some of the functions may be implemented by software or firmware. As described above, the processing circuitry can implement each function of the signal processing unit 8 in the laser radar device by hardware, software, firmware, or a combination thereof.

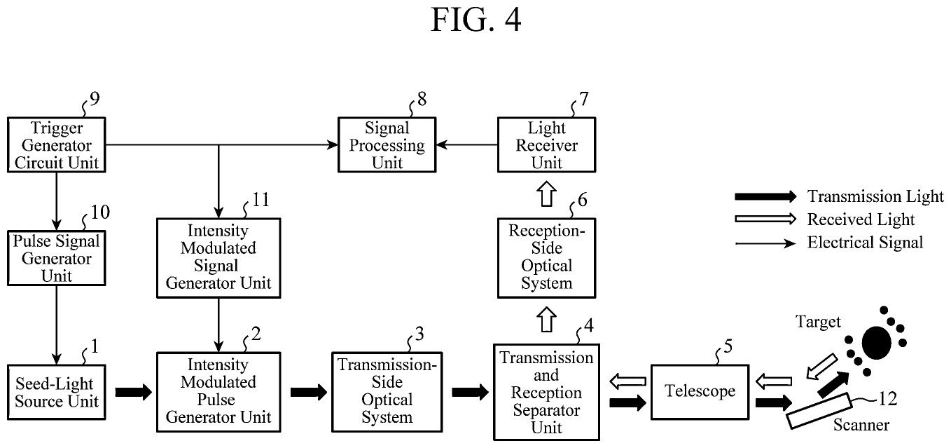

FIG. 4 is a block diagram illustrating functional blocks of the laser radar device according to the first embodiment. As illustrated in FIG. 4, the laser radar device includes a seed-light source unit 1, an intensity modulated pulse generator unit 2, a transmission-side optical system 3, a transmission and reception separator unit 4, a telescope 5, a reception-side optical system 6, a light receiver unit 7, the signal processing unit 8, a trigger generator circuit unit 9, a pulse signal generator unit 10, an intensity modulated signal generator unit 11, and a scanner 12. The arrows connecting the functional blocks illustrated in FIG. 4 include three modes, that is, a mode indicating transmission light, a mode indicating received light R, and a mode indicating an electrical signal, and indicate the type of information to be transferred between the functional blocks and the direction in which the information is transferred.

The transmission light is generated by the seed-light source unit 1, and is emitted toward an external target via the intensity modulated pulse generator unit 2, the transmission-side optical system 3, the transmission and reception separator unit 4, the telescope 5, and the scanner 12.

The received light R reflected by the target and received is guided to the light receiver unit 7 via the scanner 12, the telescope 5, the transmission and reception separator unit 4, and the reception-side optical system 6.

The electrical signals illustrated in FIG. 4 are roughly divided into two. One includes a trigger signal generated by the trigger generator circuit unit 9 and a signal generated on the basis of the trigger signal. The other includes a received electrical signal generated by photoelectric conversion of the received light R in the light receiver unit 7.

### <Seed-Light Source Unit 1>

The seed-light source unit 1 generates pulsed light. More specifically, the seed-light source unit 1 includes a light source for generating pulsed light or a pulsed laser in a single pulse or repeatedly. The seed-light source unit 1 may generate pulsed light by Q-switching, mode-locking, or pulse excitation. In addition, the seed-light source unit 1 may generate pulsed light by pulsing continuous wave laser light with an optical switch. The generated pulsed light may have any of a single wavelength, a wavelength spread to a certain extent that cannot be called a single wavelength, and a plurality of wavelengths that are simultaneously present. The pulsed light generated by the seed-light source unit 1 is transmitted to the intensity modulated pulse generator unit 2 as transmission light. The pulsed light generated by the seed-light source unit 1 has a variable seed-light pulse width.

Note that the seed-light source unit 1 generates pulsed light on the basis of a pulse signal from the pulse signal generator unit 10 to be described later.

### <Trigger Generator Circuit Unit 9>

The trigger generator circuit unit 9 generates a trigger signal (hereinafter referred to as “pulse-irradiation trigger signal”) that gives the timing to emit pulsed light. The trigger generator circuit unit 9 may be implemented by, for example, a pulse generator, a function generator, or an FPGA. The pulse-irradiation trigger signal generated by the trigger generator circuit unit 9 is transmitted to the signal processing unit 8, the pulse signal generator unit 10, and the intensity modulated signal generator unit 11.

### <Pulse Signal Generator Unit 10>

The pulse signal generator unit 10 generates a pulse signal on the basis of the transmitted pulse-irradiation trigger signal. The pulse signal generator unit 10 may also be implemented by, for example, a pulse generator, a function generator, or an FPGA. The pulse signal generated by the pulse signal generator unit 10 is transmitted to the seed-light source unit 1.

### <Intensity Modulated Signal Generator Unit 11>

The intensity modulated signal generator unit 11 generates an intensity modulated signal. More specifically, the intensity modulated signal generator unit 11 generates an intensity modulated signal on the basis of the transmitted pulse-irradiation trigger signal. The intensity modulated signal generator unit 11 may also be implemented by, for example, a pulse generator, a function generator, or an FPGA. The intensity modulated signal generated by the intensity modulated signal generator unit 11 is transmitted to the intensity modulated pulse generator unit 2.

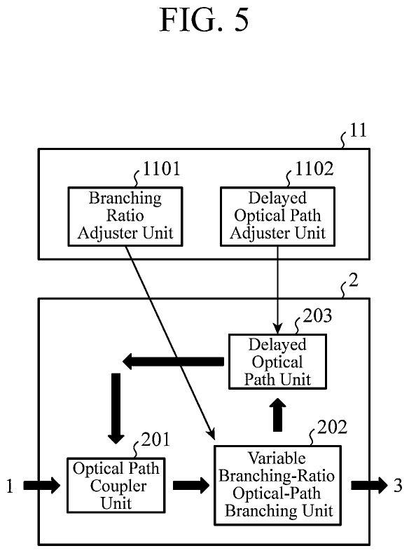

Details of the function of the intensity modulated signal generator unit 11 will be apparent later from the description with reference to FIG. 5.

### <Intensity Modulated Pulse Generator Unit 2>

The intensity modulated pulse generator unit 2 generates intensity modulated pulsed light on the basis of the transmitted pulsed light and intensity modulated signal. The intensity modulated pulsed light generated by the intensity modulated pulse generator unit 2 is transmitted to the transmission-side optical system 3.

Details of the function of the intensity modulated pulse generator unit 2 will be apparent later from the description with reference to FIG. 5.

### <Transmission-Side Optical System 3>

The transmission-side optical system 3 shapes a train (hereinafter referred to as “intensity modulated pulse train”) in which the intensity modulated pulsed light transmitted from the intensity modulated pulse generator unit 2 is continuous into a beam diameter and a divergence angle based on design specifications. The transmission-side optical system 3 may include a lens group including a concave lens and a convex lens. The transmission-side optical system 3 may include a reflective optical system using a mirror. The purpose of the transmission-side optical system 3 to shape the beam diameter and the divergence angle of the intensity modulated pulse train is to increase a signal noise ratio (SNR). Therefore, in a case where the intensity modulated pulse train has an SNR that meets the design specifications without shaping the intensity modulated pulse train, the transmission-side optical system 3 may simply be the path of the intensity modulated pulse train.

Note that, although not clearly illustrated in FIG. 4, an optical system performing an operation on pulsed light such as light amplification, wavelength conversion, and frequency shift may be disposed between the seed-light source unit 1 and the intensity modulated pulse generator unit 2, and between the intensity modulated pulse generator unit 2 and the transmission-side optical system 3.

### <Transmission and Reception Separator Unit 4>

The transmission and reception separator unit 4 is a separator that separates each of transmission light and received light R into each of ports. The transmission and reception separator unit 4 can be implemented by a polarization beam splitter or a circulator. In a case where the laser light of the transmission light and the received light R is propagated in space, the transmission and reception separator unit 4 can be implemented as a polarization beam splitter disposed on the optical axis between the transmission-side optical system 3 and the telescope 5. In a case where the laser light of the transmission light and the received light R is propagated by an optical fiber, the transmission and reception separator unit 4 can be implemented by a circulator.

The transmission light having passed through the transmission and reception separator unit 4 is transmitted to the telescope 5. The received light R having passed through the transmission and reception separator unit 4 is transmitted to the reception-side optical system 6.

### <Telescope 5>

In general, the term “telescope” means a telescope.

The telescope 5 of the laser radar device according to the first embodiment is a component with the same structure as the telescope. The telescope 5 may include a lens group including a concave lens and a convex lens. In addition, the telescope 5 may include a reflective optical system using a mirror.

The transmission light having passed through the telescope 5 is transmitted to the scanner 12. The received light R having passed through the telescope 5 is transmitted to the transmission and reception separator unit 4.

### <Scanner 12>

The scanner 12 is, for example, a galvano scanner, and a galvano mirror may be attached to a galvano motor. The galvano mirror is also referred to as “scan mirror” or “scanner mirror”. The scanner 12 is controlled in a way that the transmission light is directed toward the target. The received light R reflected by the target and received is transmitted to the light receiver unit 7 via the scanner 12, the telescope 5, the transmission and reception separator unit 4, and the reception-side optical system 6.

### <Reception-Side Optical System 6>

The reception-side optical system 6 shapes the received light R having passed through the transmission and reception separator unit 4 into a beam diameter and a divergence angle based on design specifications. The reception-side optical system 6 may include a lens group including a concave lens and a convex lens. The reception-side optical system 6 may include a reflective optical system using a mirror. The purpose of the reception-side optical system 6 to shape the beam diameter and the divergence angle of the received light R is to increase the SNR. Therefore, in a case where the received light R has an SNR that meets the design specifications without shaping the received light R, the reception-side optical system 6 may simply be the path of the received light R.

### <Light Receiver Unit 7>

The light receiver unit 7 photoelectrically converts the received light R to generate a received electrical signal. The generated received electrical signal is transmitted to the signal processing unit 8.

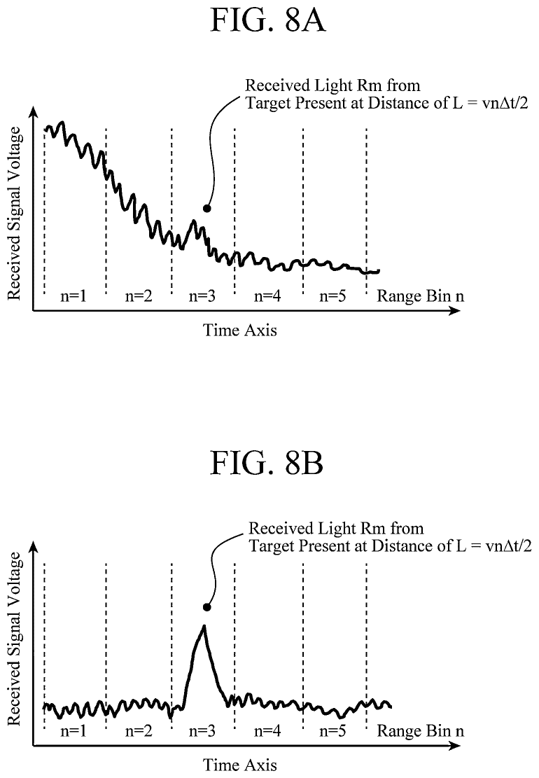

FIG. 8A is an example of a time axis graph of the received electrical signal output from the light receiver unit 7. The vertical axis of the graph shown in FIG. 8A represents the voltage of the received electrical signal, and has an axis title of “received signal voltage”.

FIG. 5 is a block diagram illustrating functional blocks of the intensity modulated pulse generator unit 2 and the intensity modulated signal generator unit 11 in the laser radar device according to the first embodiment. The intensity modulated pulse generator unit 2 and the intensity modulated signal generator unit 11 are functional blocks that perform intensity modulation on transmission light.

As illustrated in FIG. 5, the intensity modulated pulse generator unit 2 includes an optical path coupler unit 201, a variable branching-ratio optical-path branch unit 202, and a delayed optical path unit 203.

As illustrated in FIG. 5, the intensity modulated signal generator unit 11 includes a branching ratio adjuster unit 1101 and a delayed optical path adjuster unit 1102.

The optical path coupler unit 201, the variable branching-ratio optical-path branch unit 202, and the delayed optical path unit 203 in the intensity modulated pulse generator unit 2 are coupled in a loop shape. The light beam from the seed-light source unit 1 and the light beam from the delayed optical path unit 203 are input to the optical path coupler unit 201, and the light coupled here is output to the variable branching-ratio optical-path branch unit 202. The optical path coupler unit 201 may be implemented by a coupler, a polarization beam splitter, or the like. The variable branching-ratio optical-path branch unit 202 outputs one branched light beam to the transmission-side optical system 3 and outputs the other branched light beam to the delayed optical path unit 203 on the basis of a branching-ratio adjustment signal to be described later. The light from the optical path coupler unit 201 is input to the variable branching-ratio optical-path branch unit 202, and the light branched here is output to the delayed optical path unit 203 and the transmission-side optical system 3. The variable branching-ratio optical-path branch unit 202 may be implemented by appropriately combining a phase modulator, a Pockels cell, an optical wavelength plate, and a polarization beam splitter. The variable branching-ratio optical-path branch unit 202 acquires a branching-ratio adjustment signal from the branching ratio adjuster unit 1101 and adjusts the branching ratio on the basis of the branching-ratio adjustment signal. The delayed optical path unit 203 is used to adjust a phase difference between two light beams coupled by the optical path coupler unit 201, and may be implemented by a mirror, a fiber, or the like. The degree of delay or the delayed optical path length L_{Del} of the delayed optical path unit 203 is changed by a control signal from the delayed optical path adjuster unit 1102 to be described later.

The branching ratio adjuster unit 1101 in the intensity modulated signal generator unit 11 outputs a branching-ratio adjustment signal for determining the branching ratio in the variable branching-ratio optical-path branch unit 202. More specifically, the branching ratio adjuster unit 1101 generates a branching-ratio adjustment signal that is a control signal for adjusting the branching ratio in the variable branching-ratio optical-path branch unit 202, and controls the variable branching-ratio optical-path branch unit 202.

The delayed optical path adjuster unit 1102 in the intensity modulated signal generator unit 11 generates a control signal (hereinafter, referred to as “delayed optical path control signal”) for adjusting the degree of delay or the delayed optical path length L_{Del} in the delayed optical path unit 203, and controls the delayed optical path unit 203.

### <Signal Processing Unit 8>

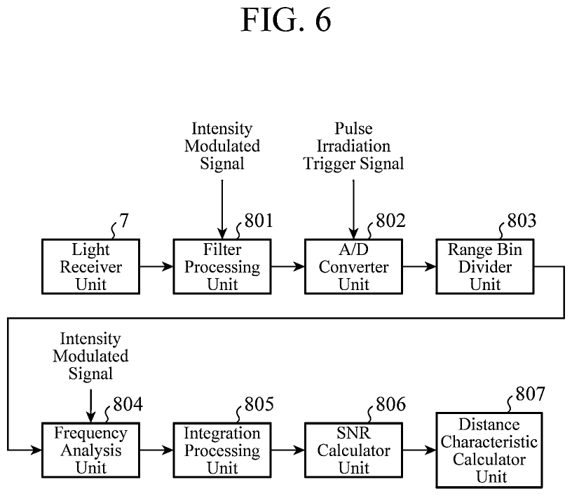

FIG. 6 is a block diagram illustrating functional blocks of the signal processing unit 8 in the laser radar device according to the first embodiment. As illustrated in FIG. 6, the signal processing unit 8 has functional blocks including a filter processing unit 801, an analog-to-digital converter unit (A/D converter unit) 802, a range bin divider unit 803, a frequency analyzer unit 804, an integration processing unit 805, an SNR calculator unit 806, and a distance characteristic calculator unit 807 in a mode in which these are connected in series in order.

The filter processing unit 801 of the signal processing unit 8 performs filter processing on the received electrical signal from the light receiver unit 7. The filter processing unit 801 is specifically a band-pass filter. The filter processing unit 801 performs the filter processing on the basis of the intensity modulated signal from the intensity modulated signal generator unit 11.

Note that FIG. 4 does not illustrate an arrow from the block of the intensity modulated signal generator unit 11 to the block of the signal processing unit 8, but this is merely because visibility of the entire diagram is prioritized.

The analog-to-digital converter unit 802 of the signal processing unit 8 converts the analog electrical signal after the filtering processing from the filter processing unit 801 into a digital electrical signal. The analog-to-digital converter unit 802 performs AD conversion processing on the basis of the pulse-irradiation trigger signal from the trigger generator circuit unit 9.

The range bin divider unit 803 of the signal processing unit 8 divides the digital electrical signal, which is the output of the analog-to-digital converter unit 802, in a time direction with a width corresponding to a pulse width. The range bin divider unit 803 performs range bin dividing processing on the basis of the pulse-irradiation trigger signal from the trigger generator circuit unit 9. In FIG. 8, the range bin is a section obtained by dividing the time axis as the horizontal axis at equal intervals, and in the example of FIG. 8, range bin labels n of 1 to 5 are attached to the individual range bins.

The frequency analyzer unit 804 of the signal processing unit 8 performs fast Fourier transform (FFT) on a bin-by-bin signal after the range bin dividing processing. By performing the fast Fourier transform, the bin-by-bin signal is converted into a bin-by-bin spectrum. The frequency analyzer unit 804 performs the fast Fourier transform on the basis of the intensity modulated signal from the intensity modulated signal generator unit 11.

The integration processing unit 805 of the signal processing unit 8 integrates a plurality of spectra obtained from data of a plurality of shots with the same frequency in a spectrum space. The integration processing has similar effects to averaging processing, and is expected to improve the SNR.

FIG. 8B is an example of a time axis graph of a received electrical signal output from the integration processing unit 805. FIG. 8B is a graph showing how a received electrical signal is processed by the signal processing unit 8 according to the first embodiment by comparison with FIG. 8A. In the graph shown in FIG. 8A, it is possible to slightly confirm a peak reflecting scattered light from the target in the region of the range bin label n of 3. However, in any range bin, there are a plurality of small peaks due to noise, the SNR is low, and it is difficult to extract a signal buried in the noise. On the other hand, in the graph shown in FIG. 8B, it is possible to clearly confirm the peak reflecting the scattered light from the target in the region of the range bin label n of 3. This is due to the effects of the frequency analyzer unit 804 and the integration processing in the integration processing unit 805.

The SNR calculator unit 806 of the signal processing unit 8 calculates the SNR of the received electrical signal. The SNR calculator unit 806 calculates the SNR for each range bin.

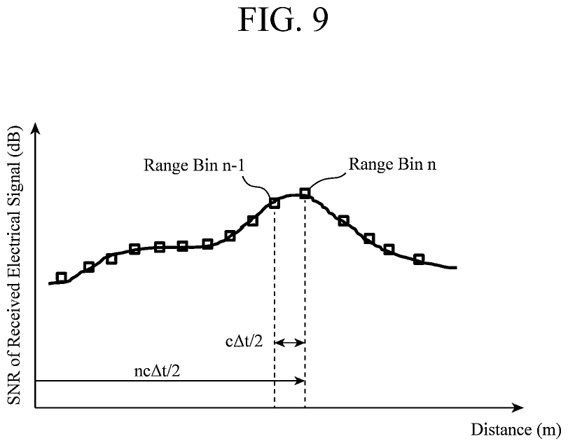

The distance characteristic calculator unit 807 of the signal processing unit 8 calculates the relationship (hereinafter, referred to as “distance characteristic”) between the distance and the SNR for each intensity modulation frequency f_{AM}. The distance characteristic can be displayed with SNR on the vertical axis and distance on the horizontal axis in the same manner as in the A-scope in which the waveform is displayed with received signal intensity on the vertical axis and distance on the horizontal axis. FIG. 9 is an example of a graph showing the distance characteristic in a manner of the A-scope. It can also be said that FIG. 9 shows a result of processing the received electrical signal by the signal processing unit 8.

The distance on the horizontal axis of the graph illustrated in FIG. 9 is obtained only by the principle of TOF. At shown in FIG. 9 represents the time interval from the start to the end of one range bin. c shown in FIG. 9 represents the speed of light. The reason why the formula illustrated in FIG. 9 is divided by two is that light used for distance measurement reciprocates from the laser radar device to the target.

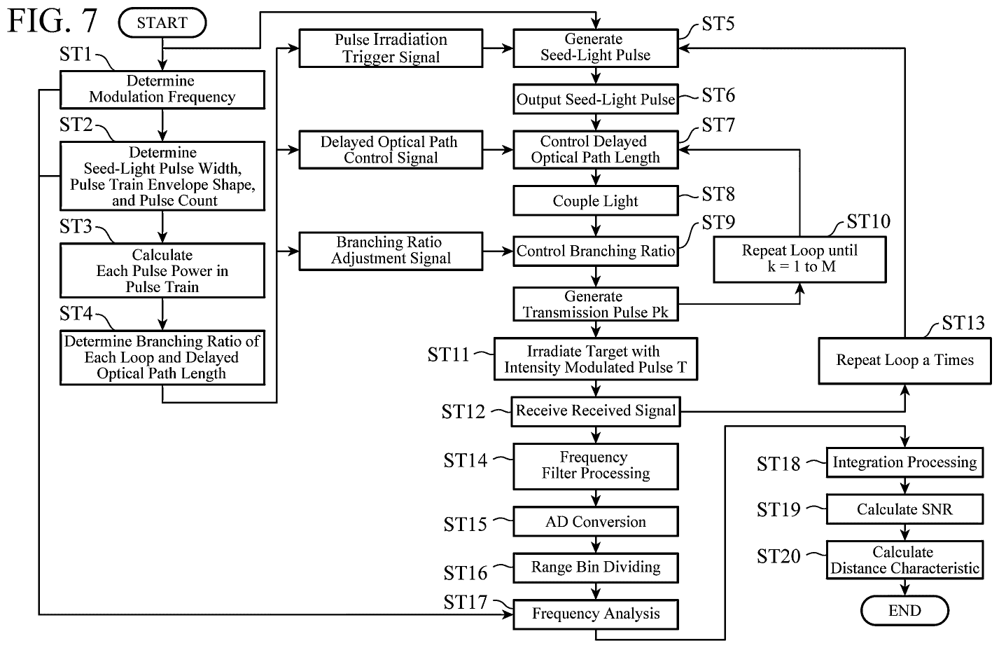

FIG. 7 is a flowchart illustrating processing steps performed by the laser radar device according to the first embodiment. As illustrated in FIG. 7, the processing steps of the laser radar device include steps ST1 to ST20.

Meanwhile, it is conceivable that the laser radar device according to the present disclosed technology measures a target in a medium with a strong scattering property such as water mist or dust. In this case, the substance with strong scattering property such as water mist or dust is referred to as “volume target”, and the measurement target in the volume target is referred to as “hard target”, and these two are distinguished from each other. The difference between the volume target and the hard target can also be expressed by the difference in the behavior of scattered light. That is, a large number of volume targets are present in a certain spatial distribution, and scattered light at each spatial position on the transmission light coordinate axis is superimposed on the target and received. The hard target is a target on which light is diffused or reflected by the light receiving surface and scattered light is not superimposed. FIG. 1A illustrates a state where the laser radar device measures the hard target in the volume target. In FIG. 1A, the substantially elliptical object shown as “target” is a hard target, and a plurality of substantially circular objects shown around the target are volume targets.

Step ST1 is a step in which the laser radar device assists a user to determine the intensity modulation frequency f_{AM}. The intensity modulation frequency f_{AM} may be determined in consideration of the characteristics of the volume target. More specifically, the intensity modulation frequency f_{AM} may be determined in consideration of the extinction coefficient and the refractive index of the volume target.

The intensity modulation frequency f_{AM} of the laser radar device according to the first embodiment may be time-invariant or may be time-varying like a chirp frequency. In addition, the intensity modulation frequency f_{AM} may be a single frequency or a mixed frequency including a plurality of frequencies.

The laser radar device according to the present disclosed technology includes a display (not illustrated), and displays information for determining the intensity modulation frequency f_{AM} for the user of the laser radar device. Furthermore, the laser radar device according to the present disclosed technology includes a keyboard, a mouse, and the like (not illustrated), and is programmed in a way that the intensity modulation frequency f_{AM} determined by the user can be input to the laser radar device.

Step ST2 is a step in which the laser radar device assists the user to determine the seed-light pulse width δt, the envelope shape A, and the pulse train width δtₘ. Here, the envelope shape A represents the relationship between the time axis and the power in the entire pulse train. The seed-light pulse width δt, the envelope shape A, and the pulse train width δtₘ may be determined on the basis of the design specifications such as the intensity modulation frequency f_{AM} determined in step ST1, the filter characteristic in the filter processing unit 801, a spectrum width, and distance resolution.

The laser radar device according to the present disclosed technology displays, on the display, the design specifications such as the intensity modulation frequency f_{AM} determined in step ST1, the filter characteristic in the filter processing unit 801, the spectral width, and the distance resolution. In addition, the laser radar device according to the present disclosed technology is programmed in a way that the seed-light pulse width δt, the envelope shape A, and the pulse train width δtₘ determined by the user can be input to the laser radar device.

The pulse train width δtₘ may be determined in consideration of the delayed optical path length L_{Del} in the delayed optical path unit 203 of the intensity modulated pulse generator unit 2. The delayed optical path length L_{Del} in the delayed optical path unit 203 of the intensity modulated pulse generator unit 2 is equal to the distance that light travels in the period (1/f_{AM}) of the intensity modulated signal as follows.

$${L}_{Del} = \frac{c}{{f}_{AM}} \qquad ( 4 )$$

wherein c represents the speed of light. In this case, the pulse train width δtₘmay satisfy the following relational expression.

$$δ {t}_{m} = \frac{1}{{f}_{AM}} \qquad ( 5 )$$

Step ST3 is a step in which the laser radar device discretizes the envelope shape A of a pulse and calculates a design value of the optical power of each pulse constituting the pulse train.

The number of pulses constituting the pulse train is assumed to be M. Further, a pulse that is output to the transmission-side optical system 3 after passing through the variable branching-ratio optical-path branch unit 202 for the k-th time (k is any number from 1 to M) is referred to as “k-th pulse Pₖ”. In this case, the loop count in the intensity modulated pulse generator unit 2 is M−1.

That is, step ST3 represents a step of calculating the design value of the optical power for each of pulses (P₁, P₂, . . . . P_{M}) during the loop time in the intensity modulated pulse generator unit 2.

Step ST4 is a processing step performed by the branching ratio adjuster unit 1101. In step ST4, the branching ratio adjuster unit 1101 calculates the branching ratio in the variable branching-ratio optical-path branch unit 202. Specifically, the branching ratio adjuster unit 1101 calculates a branching ratio on condition that a number of a loop count in the variable branching-ratio optical-path branch unit 202 is k, on the basis of the following formula.

$$for k = 1 to M , \frac{{𝒫}_{out}}{{𝒫}_{loop}} = \frac{{\sum }_{i = k + 1}^{M} {𝒫}_{i}}{{𝒫}_{k}} \qquad ( 6 )$$

wherein script font “P” in formula (6) represents optical power. The script font “P” with a subscript “k” represents the optical power of the k-th pulse Pₖ. In addition, the script font “P” with a subscript “out” represents the optical power of light output to the transmission-side optical system 3. The script font “P” with a subscript “loop” represents the optical power of light output to the delayed optical path unit 203.

That is, formula (6) represents that the branching ratio adjuster unit 1101 calculates, on the basis of the optical power of the k-th pulse Pₖ in the pulse train and the sum of the optical power of the (k+1)-th to last pulses in the pulse train, the branching ratio on condition that a number of a loop count in the variable branching-ratio optical-path branch unit 202 is k.

By adopting the branching ratio expressed by formula (6), the optical power of the light output to the transmission-side optical system 3 becomes equal to the design value of the optical power calculated in step ST3.

Step ST4 also includes a step of generating a branching-ratio adjustment signal for the branching ratio of the variable branching-ratio optical-path branch unit 202 to be a value represented by formula (6). Step ST4 also includes a step of generator a delayed optical path control signal for adjusting the delayed optical path unit 203.

Step ST5 is a processing step performed by the pulse signal generator unit 10. In step ST5, the pulse signal generator unit 10 controls the seed-light source unit 1 on the basis of a pulse-irradiation trigger signal. The seed-light source unit 1 controlled by the pulse signal generator unit 10 generates a light pulse with a repetition period Tᵣₑₚand a seed-light pulse width δₜ. The upper part of FIG. 1B shows that the light pulse with the seed-light pulse width δₜ is generated every repetition period Tᵣₑₚ.

Step ST6 is a processing step performed by the seed-light source unit 1. In step ST6, the seed-light source unit 1 outputs the generated light pulse to the intensity modulated pulse generator unit 2.

Step ST7 is a processing step performed by the delayed optical path adjuster unit 1102. In step ST7, the delayed optical path adjuster unit 1102 controls the optical path length of the delayed optical path unit 203.

Step ST8 is a processing step performed by the optical path coupler unit 201. In step ST8, the optical path coupler unit 201 couples the light from the seed-light source unit 1 with the light from the delayed optical path unit 203. In addition, in step ST8, the optical path coupler unit 201 outputs the coupled light to the variable branching-ratio optical-path branch unit 202.

Step ST9 is a processing step performed by the variable branching-ratio optical-path branch unit 202. In step ST9, the variable branching-ratio optical-path branch unit 202 outputs one of the branched light to the transmission-side optical system 3 and outputs the remaining branched light to the delayed optical path unit 203 on the basis of the branching-ratio adjustment signal. Note that the light branched to the delayed optical path unit 203 is propagated through the designed delayed optical path length L_{Del} and then transmitted to the optical path coupler unit 201.

Step ST10 represents that the processing steps from steps ST7 to ST9 are loop processing that is repeated M times.

By the processing steps ST7 to ST9 being repeatedly performed M times as described above, the intensity modulated pulse generator unit 2 converts the light pulse generated by the seed-light source unit 1 into a light pulse train including intensity modulated light pulses (alternatively, simply referred to as “intensity modulated pulses T”) and outputs the light pulse train to the transmission-side optical system 3. Note that the alphabet “T” used here is derived from a transmitter in English meaning a transmitter. A subscript added to “T” (for example, “m” of the m-th intensity modulated pulse Tₘ) is simply a serial number that changes to 1, 2 . . . in chronological order (see FIG. 1B).

Step ST11 is a processing step performed by the telescope 5 and the scanner 12.

In step ST11, the telescope 5 outputs the intensity modulated pulse T (for example, m-th intensity modulated pulse Tₘ) to the scanner 12.

In step ST11, the scanner 12 rotates a scanner mirror in a way that the intensity modulated pulse T is emitted toward the target. The emitted intensity modulated pulse T is emitted toward the hard target present in the volume target, and the received light R is generated by reflection and scattering. Note that the alphabet “R” used here is derived from a receiver in English meaning a receiver. In addition, a subscript added to “R” (for example, “m” of the m-th received light Rₘ) is also a serial number that changes to 1, 2, . . . in chronological order (see FIG. 1B).

Step ST12 is a processing step performed by the telescope 5, the scanner 12, and the transmission and reception separator unit 4, the reception-side optical system 6, and the light receiver unit 7 which are functional blocks on the reception side.

In step ST12, the telescope 5 outputs the received light R received (for example, first received light R₁) to the transmission and reception separator unit 4.

Step ST12 includes a step that the transmission and reception separator unit 4 outputs the received light R to the reception-side optical system 6, a step that the reception-side optical system 6 processes the received light R, and a step that the reception-side optical system 6 outputs the received light R having passed through the reception-side optical system 6 to the light receiver unit 7. In addition, step ST12 includes a step that the light receiver unit 7 converts the received light R into a received electrical signal and a step that the light receiver unit 7 outputs the received electrical signal to the signal processing unit 8.

Step ST13 represents that the processing steps from steps ST5 to ST12 are loop processing repeated “a” times. Here, “a” is the number of times of pulse integration “a”. The number of times of pulse integration “a” is a design parameter for determining the SNR of the laser radar device. The laser radar device according to the present disclosed technology may have a configuration in which a screen for performing initial setting is displayed on a display, and a user can freely set the number of times of pulse integration “a” in the initial setting.

Steps ST14 to ST17 are processing steps performed by the signal processing unit 8, but the laser radar device may sequentially perform the processing or may perform the processing at once after the loop processing from step ST5 to step ST12 repeated “a” times is completed.

Step ST14 is a processing step performed by the filter processing unit 801. In step ST14, the filter processing unit 801 performs filter processing on the received electrical signal on the basis of the intensity modulated signal from the intensity modulated signal generator unit 11. Note that the frequency of the intensity modulated signal is represented by the symbol f_{AM} used in formula (4).

Step ST15 is a processing step performed by the analog-to-digital converter unit 802. In step ST15, the analog-to-digital converter unit 802 converts the received analog electrical signal corresponding to the received light R into a digital signal. The digital conversion processing performed by the analog-to-digital converter unit 802 uses the pulse-irradiation trigger signal from the trigger generator circuit unit 9 as a start trigger. That is, the start time of the digital conversion processing performed by the analog-to-digital converter unit 802 matches in principle the timing when pulsed light is emitted. The digital conversion processing performed by the analog-to-digital converter unit 802 is continued for a predetermined period of time or until the next pulsed light is emitted.

It can be seen from the principle of TOF that the signal digitally converted after ΔT from the start of the digital conversion, that is, from the emission of the pulsed light is reflected by a target at a place separated by a distance (L) expressed by the following formula.

$$L = c \frac{Δ T}{2} \qquad ( 7 )$$

Note that the length unit for digitally converting the received electrical signal may be one pulse.

Step ST16 is a processing step performed by the range bin divider unit 803. In step ST16, the range bin divider unit 803 divides the received electrical signal converted into a digital signal into range-bin-by-range-bin signals.

FIG. 8A is a time axis graph showing the k-th received light Rk obtained by emitting one pulse, for example, the k-th pulse Pₖ, reflecting the pulse by the target, and inputting the pulse to the laser radar device. “n” shown in FIG. 8A is a label attached to a range bin, and a smaller range bin label “n” means that the target is closer to the laser radar device. The width of the range bin, that is, the time interval Δt from the start to the end of one range bin, may be equal to the seed-light pulse width δt. As described above, the laser radar device according to the present disclosed technology may be programmed in a way that design parameters including the seed-light pulse width δt determined by the user can be input to the laser radar device.

Step ST17 is a processing step performed by the frequency analyzer unit 804. In step ST17, the frequency analyzer unit 804 performs Fourier transform on the received signals divided into the individual range bins to calculate a spectrum. Furthermore, in step ST17, the frequency analyzer unit 804 outputs the calculated spectrum to the integration processing unit 805.

As described above, the intensity modulation frequency f_{AM} of the laser radar device may be time-invariant or may be time-varying like a chirp frequency. That is, the intensity modulation frequency f_{AM} may be different for each pulse. The intensity modulation frequency f_{AM} of the m-th intensity modulated pulse Tₘ is expressed as an m-th intensity modulation frequency f_{AM_m} to be distinguished.

In the spectrum obtained by the Fourier transform of the digitally converted received electrical signal of the m-th received light Rₘ, the peak frequency substantially matches the m-th intensity modulation frequency f_{AM_m}. Strictly speaking, a frequency shift may occur due to the movement of the target, and the like, but there is no problem in describing the principle of the present disclosed technology on the assumption that the peak frequency matches the m-th intensity modulation frequency f_{AM_m}.

Step ST18 is a processing step performed by the integration processing unit 805. In step ST18, the integration processing unit 805 integrates spectra transmitted by the number of times of pulse integration “a”.

Step ST19 is a processing step performed by the SNR calculator unit 806. In step ST19, the SNR calculator unit 806 calculates the ratio between peak intensity and out-of-band noise, and sets the ratio as the SNR of the spectrum. The ratio between the peak intensity and the out-of-band noise is calculated for each range bin. In step ST19, the SNR calculator unit 806 outputs the integrated spectrum and the SNR for each range bin to the distance characteristic calculator unit 807.

Step ST20 is a processing step performed by the distance characteristic calculator unit 807. In step ST20, the distance characteristic calculator unit 807 converts the transmitted SNR information for each range bin into SNR information for each distance. Note that, as illustrated in FIG. 8, the range bin in the present disclosed technology has a physical unit of time (or also referred to as “dimension”). The unit of time may be converted into the unit of distance in accordance with the principle of TOF.

Since the laser radar device according to the first embodiment includes the variable branching-ratio optical-path branch unit 202 and the branching ratio adjuster unit 1101, there is an effect that the shape A of the amplitude modulation envelope can be deformed by an external operation. In addition, since the laser radar device according to the first embodiment includes the intensity modulated pulse generator unit 2 including the optical path coupler unit 201, the variable branching-ratio optical-path branch unit 202, and the delayed optical path unit 203, unlike the conventional technique, there is an effect that the shape A of the amplitude modulation envelope can be deformed by an external operation for any type of seed-light source unit 1 for the first time.

Since the laser radar device according to the first embodiment includes the intensity modulated pulse generator unit 2 including the optical path coupler unit 201, the variable branching-ratio optical-path branch unit 202, and the delayed optical path unit 203, there is an effect that the intensity modulation frequency f_{AM} can be made variable.

Since the laser radar device according to the first embodiment has the effects, there is an effect that the distance resolution and the maximum measurement distance can be freely adjusted depending on the purpose of distance measurement.

### Second Embodiment

The laser radar device according to the first embodiment is a device that adopts a direct detection method, but the present disclosed technology is not limited thereto.

The second embodiment will clarify some modifications of the laser radar device described in the first embodiment.

The laser radar device according to the second embodiment may be a coherent lidar, a differential absorption lidar, or a dual-polarization lidar.

In a case where the laser radar device is a coherent lidar, the laser radar device can measure not only position information of a target but also velocity information of the target.

In a case where the laser radar device is a differential absorption lidar, the components of the laser radar device are slightly different from those in the first embodiment. In the laser radar device in the case of the differential absorption lidar, the seed-light source unit 1 outputs a first intensity modulated pulse with a first wavelength and a second intensity modulated pulse with a second wavelength different from the first wavelength. In the laser radar device in the case of the differential absorption lidar, the signal processing unit 8 calculates the intensity ratio of received signals individually corresponding to the first intensity modulated pulse and the second intensity modulated pulse. With this configuration, the laser radar device in the case of the differential absorption lidar can measure the absorption wavelength and the concentration of the target in addition to the position information of the target.

In a case where the laser radar device is a dual-polarization lidar, the components of the laser radar device are slightly different from those in the first embodiment. In the laser radar device in the case of the dual-polarization lidar, the seed-light source unit 1 outputs intensity modulated pulses that are two orthogonal polarized light beams. In addition, in the laser radar device in the case of the dual-polarization lidar, the signal processing unit 8 calculates the intensity ratio of received signals individually corresponding to the two orthogonal polarized light beams. With this configuration, the laser radar device in the case of the differential absorption lidar can measure the particle shape of the target in addition to the position information of the target.

As illustrated in FIG. 4, the laser radar device according to the first embodiment includes a bidirectional optical system for transmission and reception between the transmission and reception separator unit 4 and the telescope 5 and between the telescope 5 and the scanner 12. However, the laser radar device according to the present disclosed technology is not limited to this configuration. The laser radar device according to the present disclosed technology may be configured that the telescope 5 is provided separately for transmission and for reception.

In addition to the configuration described in the first embodiment, the laser radar device according to the second embodiment may include a feedback mechanism that performs a plurality of measurements while changing the parameters (hereinafter, referred to as “pulse train parameters”) of the pulse train used by the laser radar device and compares the measurement results, thereby optimizing the pulse train parameters.

The pulse train parameters may be optimized in a way that, for example, the SNR of the received signal from the hard target is improved. Alternatively, the pulse train parameters may be optimized in a way that the SNR of the hard target is compared with the SNR of the volume target and the difference therebetween is increased.

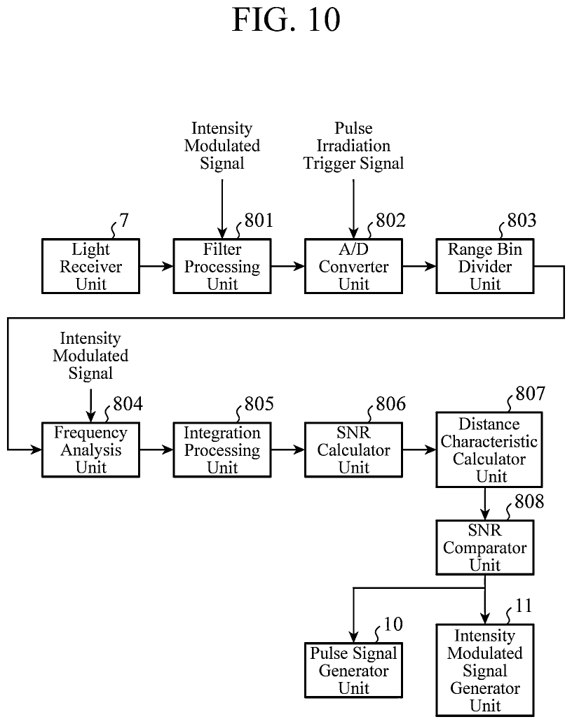

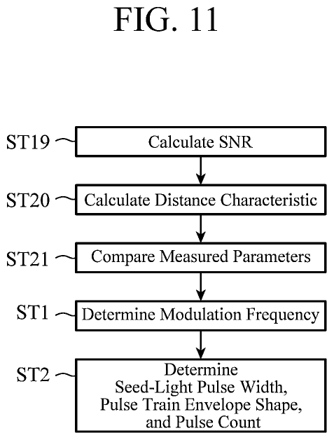

FIG. 10 is a block diagram illustrating functional blocks of the signal processing unit 8 in the laser radar device according to the second embodiment. FIG. 11 is a flowchart illustrating a part of processing steps performed by the laser radar device according to the second embodiment.

The functional block of an SNR comparator unit 808 illustrated in FIG. 10 performs a processing step of comparing SNRs in a plurality of measurement results performed while changing the pulse train parameters. FIG. 10 illustrates that the information of the pulse train parameters determined to be appropriate obtained by the SNR comparator unit 808 is fed back to the pulse signal generator unit 10 and the intensity modulated signal generator unit 11.

Step ST21 illustrated in FIG. 11 is a processing step performed by the SNR comparator unit 808. As illustrated in FIG. 11, after ST21, the process returns to step ST1. That is, the SNR comparator unit 808 is a functional block that implements the feedback mechanism.

As described above, the laser radar device according to the second embodiment provides some modifications of the laser radar device described in the first embodiment. The laser radar device according to the second embodiment has the effects clarified in the first embodiment, and has an effect that the distance resolution and the maximum measurement distance can be freely adjusted depending on the purpose of distance measurement.

### INDUSTRIAL APPLICABILITY

The laser radar device according to the present disclosed technology can be applied to distance measurement of a hard target in a volume target, and has industrial applicability.

### REFERENCE SIGNS LIST

1: Seed-light source unit, 2: Intensity modulated pulse generator unit, 3: Transmission-side optical system, 4: Transmission and reception separator unit, 5: Telescope, 6: Reception-side optical system, 7: Light receiver unit, 8: Signal processing unit, 9: Trigger generator circuit unit, 10: Pulse signal generator unit, 11: Intensity modulated signal generator unit, 12: Scanner, 100a: Processing circuitry, 100b: Processor, 100c: Memory, 201: Optical path coupler unit, 202: Variable branching-ratio optical-path branch unit, 203: Delayed optical path unit, 801: Filter processing unit, 802: Analog-to-digital converter unit, 803: Range bin divider unit, 804: Frequency analyzer unit, 805: Integration processing unit, 806: SNR calculator unit, 807: Distance characteristic calculator unit, 808: SNR comparator unit, 1101: Branching ratio adjuster unit, 1102: Delayed optical path adjuster unit

1. A laser radar device comprising:
a seed-light source to generate pulsed light;
an intensity modulated signal generator to generate an intensity modulated signal; and
an intensity modulated pulse generator to generate intensity modulated pulsed light on a basis of the pulsed light and the intensity modulated signal, wherein
the intensity modulated signal generator includes a branching ratio adjuster and a delayed optical path adjuster,
the intensity modulated pulse generator includes an optical path coupler, a variable branching-ratio optical-path branch, and a delayed optical path, which are coupled in a loop shape,
the branching ratio adjuster outputs a branching-ratio adjustment signal to determine a branching ratio in the variable branching-ratio optical-path branch, and
the variable branching-ratio optical-path branch outputs one branched light to a transmission-side optical system and outputs remaining branched light to the delayed optical path on a basis of the branching-ratio adjustment signal.

2. The laser radar device according to claim 1, wherein
the delayed optical path adjuster generates a delayed optical path control signal to adjust a degree of delay or a delayed optical path length in the delayed optical path, and
in the delayed optical path, the degree of delay or the delayed optical path length is changed on a basis of the delayed optical path control signal.

3. The laser radar device according to claim 1, wherein
the branching ratio adjuster calculates, on a basis of optical power of a k-th pulse in a pulse train and a sum of optical power of (k+1)-th to last pulses in the pulse train, the branching ratio on condition that a number of a loop count in the variable branching-ratio optical-path branch is k.

4. The laser radar device according to claim 1, wherein
the seed-light source generates the pulsed light by Q-switching, mode-locking, pulse excitation, or pulsing continuous wave laser light with an optical switch, and
a seed-light pulse width is variable.

5. The laser radar device according to claim 2, wherein
a value of the delayed optical path length can be changed by an external operation.

6. The laser radar device according to claim 3, wherein
a total number of the loop count can be changed by an external operation.

7. The laser radar device according to claim 3, wherein
the number of the loop count in the variable branching-ratio optical-path branch can be changed by an external operation.
